(19) United States
(12) Patent Application Publication
(10) Pub. No.: US 2007/0058137 A1
(43) Pub. Date: Mar. 15, 2007

(54) PROJECTION DISPLAY APPARATUS AND OPTICAL FILTER

(76) Inventors: Ching-An Yang, Kaohsiung County (TW); Shih-Min Wu, Yilan County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,570

(22) Filed: Sep. 15, 2005

(51) Int. Cl. G03B 21/16

(52) U.S. Cl. 353/52

(57) ABSTRACT

A projection display apparatus including a lighting system, a projection lens and a display device. The lighting system has a light source, a lens set, and an Yttrium Aluminum Garnet filter (YAG filter) is provided. The light source is suitable for providing a light beam. The lens set is disposed on the transmission path of the light beam. The YAG filter is disposed between the light source and the lens set and on the transmission path of the light beam as well. Additionally, the projection lens is disposed on the transmission path of the light beam. The display device is disposed between the lighting system and the projection lens and on the transmission path of the light beam as well. The projection apparatus having the YAG filter is benefited in dispelling the heat of the light source and optical devices, thereby extending lifetime of the light source and optical devices.

### BACKGROUND OF THE INVENTION

1. Field of Invention

The present invention relates to a projection display apparatus and an optical filter. In particular, the present invention relates to an optical filter capable of absorbing the infrared rays, and heat dissipation of the projection display apparatus is improved by using the optical filter.

2. Description of Related Art

In general, the projection display apparatuses in the prior art are applied in the displaying apparatuses of the front-projection type or large-screen rear-projection type, so the light sources required must be able to supply higher total luminance to have the projection image with higher brightness. Therefore, halogen lamps or a variety of high-pressure mercury lamps are widely used as light sources in projection display apparatuses. Despite the merit of high brightness, there are still many drawbacks accompanied with those light sources, such as high power consumption, short lifetime, and immense heat generation and so forth. Among those drawbacks, in particular, the immense heat generated by light sources often leads to shortened lifetime of light sources and damages of optical devices in the projection display apparatus.

FIG. 1 schematically illustrates a projection display apparatus in the prior art. Please refer to FIG. 1. The image display apparatus 100 comprises a lighting system 110, a projection lens 130, and a display unit 120. Wherein, the lighting system 110 comprises a light source 112, a lens set 116 and an ultraviolet/infrared ray filter 114 (UV/IR filter). The light source 112 is suitable for providing a light beam 140. The lens set 116 is disposed on the transmission path of the light beam 140, and the UV/IR filter 114 is disposed between the light source 112 and the lens set 116 and on the transmission path of the light beam 140 as well. Further, the projection lens 130 is disposed on the transmission path of light beam 140, and the display unit 120 is disposed between the lighting system 110 and the projection lens 130 and on the transmission path of light beam 140 as well. The display unit 120 includes a color-combination prism 120a and a display device 120b. After the modulating operation via the display device 120b and combining operation of color lights (R, G and B) via color-combination prism 120a in the display unit 120, the light beam 140 from light source 112 is projected by the projection lens 130 for forming the image.

In the projection displaying apparatus 100, several optical devices (such as the lens set 116 shown in FIG. 1) are made of organic materials. In addition to visual lights, the light beam 140 provided by the light source 112 also includes lights that cannot be visualized like the ultraviolet light 140a (UV) and infrared ray 140b (IR), etc. Once lights including the ultraviolet light 140a and the infrared ray 140b enter the lens set 116, due to excessive absorption of the ultraviolet light 140a and infrared ray 140b, damage of the lens set 116 occurs. To avoid the circumstances mentioned above, usually the UV light 140a and IR 140b are reflected back to the light source 112 for blocking the access to the optical devices located behind by placing an UV/IR filter 114 ahead of the light source 112.

FIG. 2 schematically shows for a projection display apparatus in the prior art, a spectrum diagram of light beams measured after being filtered by an UV/IR filter. Please refer to FIGS. 1 and 2 simultaneously. Lights in the visual-light region 210 (wavelengths ranging from 400 nm to 700 nm) have an averaged transmittance rate 95%. Besides, the UV lights 140a and IR 140b, in the local IR-region 220 (wavelengths ranging from 740 nm to 920 nm) and local UV-region 230 (wavelengths ranging from 200 nm to 380 nm), would hardly penetrate through the UV/IR filter 114. Namely, after passing through UV/IR filter 114, only visual lights of light beam 140 remain and IR 140a and UV lights 140b are reflected back to the light source 112.

Nevertheless, since UV lights 140a and IR 140b are reflected back to the light source 112 by the UV/IR filter 114, energy of UV lights 140a and IR 140b is accumulated on the light source 112 and that causes heavy heat-loading of the light source 112. Also, being unable to eliminate heat effectively, lifetime of the light source 112 will be shortened. The optical devices (such as the lens set 116 shown in FIG. 1) made of organic materials would probably get damaged as well.

### SUMMARY OF THE INVENTION

In view of this, one object of the present invention is to provide a projection display apparatus capable of extending lifetime of the light source and optical devices.

One another object of the present invention is to provide an optical filter suitable for absorbing the infrared rays to dissipate heat.

The present invention provides a projection display apparatus comprising a lighting system, a projection lens and a display unit. Wherein, the lighting system comprises a light source, a lens set and an Yttrium Aluminum Garnet filter (YAG filter). The light source is suitable for providing a light beam. The lens set is disposed on the transmission path of the light beam, and the YAG filter is disposed between the light source and the lens set and on the transmission path of the light beam as well. In addition, the projection lens is disposed on the transmission path of the light beam, and the display unit is disposed between the lighting system and the projection lens and on the transmission path of the light beam as well.

In one preferred embodiment of the present invention, the YAG filter mentioned above, for example, further comprises at least a coating layer disposed on the surface of the YAG filter.

In one preferred embodiment of the present invention, the coating layer mentioned above for example is an anti-reflective coating (AR coating), and the material of the anti-reflective coating includes MgF₂ or Na₃AlF₆.

In one preferred embodiment of the present invention, the coating layer mentioned above, for example, is an ultraviolet-blocking coating (UV-blocking coating) and a material of the UV-blocking coating can be a blended material of TiO₂ and SiO₂ for example.

In one preferred embodiment of the present invention, the coating layer mentioned above, for example, includes an AR coating and an UV-blocking coating.

In one preferred embodiment of the present invention, the projection display apparatus, for example, further comprises a heat-sink apparatus disposed on the side of the YAG filter.

In one preferred embodiment of the present invention, the light source mentioned above for example is an ultra high pressure lamp (UHP lamp).

In one preferred embodiment of the present invention, the lens set mentioned above includes a polarization converter and a condenser lens, for example.

In one preferred embodiment of the present invention, the display unit mentioned above, for example, includes a color-combination prism and at least a display device. And wherein, the display unit may be a liquid crystal on silicon (LCOS) display panel, a high temperature poly-silicon (HTPS) display panel, or the digital light processing (DLP) technique, for example.

The present invention provides an optical filter comprising an YAG filter and at least a coating layer. Wherein, the coating layer is disposed on the surface of the YAG filter.

In one preferred embodiment of the present invention, the coating layer mentioned above is an anti-reflective coating (AR coating) for example, and the material of the anti-reflective coating (AR coating) includes MgF₂ or Na₃AlF₆.

In one preferred embodiment of the present invention, the coating layer mentioned above for example is an ultraviolet-blocking coating (UV-blocking coating), and the material of the UV-blocking coating can be a blended material of TiO₂ and SiO₂ for example.

In one preferred embodiment of the present invention, the coating layer mentioned above includes an AR coating and an UV-blocking coating, for example.

Based on the present invention, because of the adoption of the YAG filter owning merits, including the ability of absorbing the infrared rays and a high coefficient of thermal conductivity, heat dissipation of the projection display apparatus can be improved and the accumulated heat generated by the infrared rays that cause shortened lifetime of the light source can be prevented. Moreover, the coating layer disposed on the surface of the YAG filter is helpful in reflecting the UV lights and raising the transmittance rate of visual lights, so not only the damages of optical devices made of organic materials can be avoided but also utility efficiency of lights can be increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a projection display apparatus in the prior art.

FIG. 2 schematically shows the measured spectrum of light beams after being filtered by an UV/IR filter in a projection display apparatus of the prior art.

FIG. 3 schematically shows a projection display apparatus according to one preferred embodiment of the present invention.

FIG. 4 schematically shows the measured spectrum of light beams after being filtered by the YAG filter in the projection apparatus of the present invention.

FIG. 5 schematically shows temperature measurements on the light source of the projection display apparatus of the present invention by using thermal couples.

FIG. 6 schematically shows the temperature measurements on the light source of the projection display apparatus of the present invention by using thermal couples.

FIG. 7 schematically shows an optical filter according to one preferred embodiment of the present invention.

### DESCRIPTION OF THE PREFERRED EMBODIMENTS

### The First Embodiment

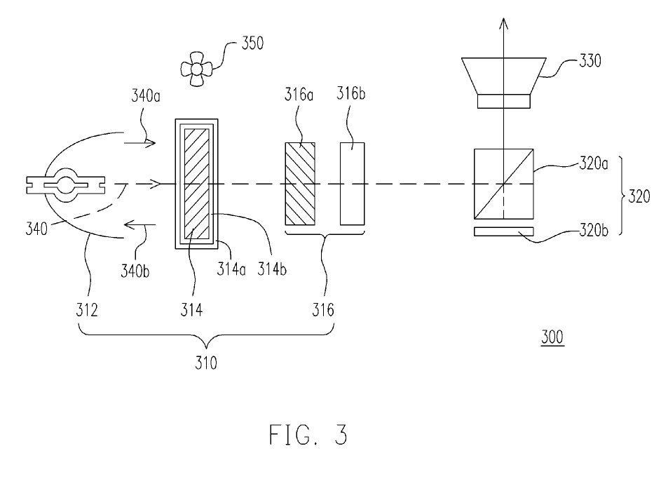

FIG. 3 schematically shows a projection display apparatus according to one preferred embodiment of the present invention. Referring to FIG. 3, the projection display apparatus 300 may comprise a lighting system 310, a projection lens 330 and a display unit 320, for example.

The lighting system 310 may comprise a light source 312, a lens set 316 and an Yttrium Aluminum Garnet filter (YAG filter) 314, for example. The light source 312 is suitable for supplying a light beam 340, and in one preferred embodiment the light source 312 can be an ultra high pressure (UHP) lamp which is filled with high-pressure mercury-vapor. The lens set 316 is disposed on the transmission path of the light beam 340, and in one preferred embodiment it may comprise a PS converter 316a for converting the P-direction and S-direction polarized lights of the light beam 340 and a condenser lens 316b for focusing the light beam 340 to enhance the intensity of the light beam 340.

Please continue to refer to FIG. 3. The YAG filter 314 in the lighting system 310 is disposed between the light source 312 and the lens set 316 and also disposed on the transmission path of the light beam 340. The YAG filter 314 made of Yttrium Aluminum Garnet features a high coefficient of thermal conductivity, a high melting point, a high transmittance rate, robust mechanical strength and high insulation capability, etc. It's worthy to note that the Yttrium Aluminum Garnet (YAG) is of mono-crystalline structure with thermal conductivity 0.12 W/cm.K that is twelve times of thermal conductivity of the glass (0.01 W/cm.K at room temperature). Thus, the YAG owns better ability of conduction heat transfer than that of the glass.

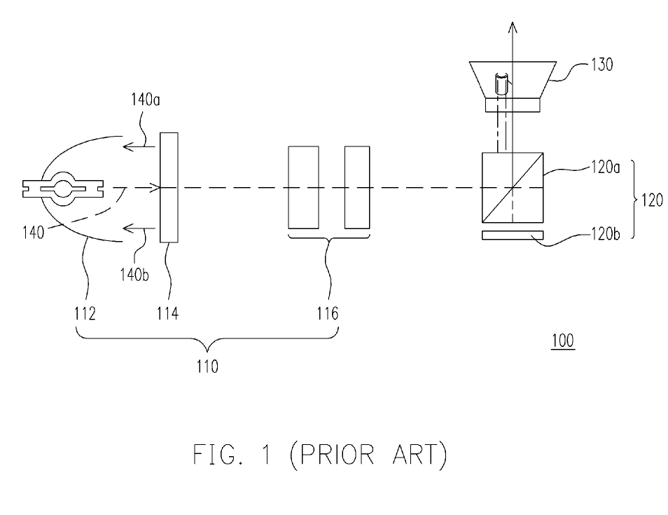

In addition, the YAG has the characteristic of absorbing infrared rays (IR), and therefore, the YAG filter 314 shown in FIG. 3 is capable of absorbing infrared rays 340a from the light source 312. In comparison with the traditional method that is to reflect the infrared rays 140a back to the light source 112 by using an UV/IR filter 114 shown in FIG. 1, the present invention is to utilize the YAG filter 314 to absorb the energy of IR 340a. Also, the YAG filter 314 with high capability of conduction heat transfer is used to effectively absorb and conduct away the heat generated by IR 340a, but not to reflect the IR 340a back otherwise. Thus, no heat loading applied on the light source 312 appears. In one preferred embodiment, the projection display apparatus, for example, further comprises a heat-sink apparatus 350 disposed on the side of the YAG filter 314. This heat-sink apparatus 350 can be a heat-sink fan that is suitable for dissipating the heat accumulated in the YAG filter 314 or the heat around the light source 312.

Refer to FIG. 3 again. It is worthy to note, in one embodiment of the present invention, at least one coating layer 314a/314b disposed on the surface of the YAG filter 314 is further comprised, for increasing the transmittance efficiency of visual lights transferring through the YAG filter 314, or for enabling the YAG filter 314 to reflect the UV lights. By doing so, not only the transmittance rate of visual lights is increased but also UV lights are prevented from entering into the optical module located behind and damaging the optical devices made of organic materials.

In one aforementioned embodiment of the present invention, the coating layer mentioned above, for example, is an anti-reflective coating (AR coating) 314a used for raising the transmittance rate of visual lights, and the material of this AR coating 314a can be MgF₂ or Na₃AlF₆, for example.

In another embodiment of the present invention, the coating layer mentioned above, for example, is an UV- blocking coating 314b used for reflecting UV lights. And the material of the UV-blocking coating can be a blended material of TiO₂ and SiO₂, for example.

Without a doubt, in one another embodiment of the present invention, the coating layer mentioned above, for example, includes both one AR coating 314a and one UV-blocking coating 314b used for further improving the performance of the YAG filter 314. For the sequence of the coating layers to be formed on the surface of the YAG filter 314, either the AR coating 314a or the UV-blocking coating 314b is fabricated first.

In a word, by using the YAG filter 314 and the coating layers 314a, 314b coated on the surface of the YAG filter 314, the projection display apparatus 300 is enabled to absorb IR 340a and dissipate the heat generated, to raise the transmittance rate of visual lights of light beam 340, and to reflect the UV lights 340b so as to prevent the UV lights 340b from damaging the optical devices made of organic materials.

Still referring to FIG. 3, the projection lens 330 in the projection display apparatus 300 is disposed on the transmission path of the light beam 340 for projecting the image data onto a screen (not shown) and displaying the image. The display unit 320 is disposed between the lighting system 310 and the projection lens 330 and disposed on the transmission path of light beam 340 as well. In one preferred embodiment of the present invention, the display unit 320 may comprise a color-combination prism 320a and at least a display device 320b, for example. Wherein, the display device 320b may be a liquid crystal on silicon (LCOS) display panel, a high temperature poly-silicon (HTPS) display panel, or the digital micro-mirror device (DMD) for the digital light processing (DLP) technique. The display unit 320 can also be the digital micro-mirror device (DMD) of the digital light processing (DLP) technique. In one embodiment, if the display unit 320 is composed of LCOS panels, then the display unit 320 can be a projection system composed of the three-panel reflective-type LCD panels, of the single-panel reflective-type LCD panels, or of the dual-panel type LCD panels. To form the images, sequential operations including modulating of light beams from the light source 312 via the display unit 320 and combining of color lights R, G and B via the color-combination prism 320b (not shown), are performed in the display unit 320. And finally the images are displayed via the projecting operation by the projection lens 330. After the modulating operation via the display device 320b and combining operation of color lights (R, G and B) via color-combination prism 320a in the display unit 320, the light beam from light source 312 is projected by the projection lens 330 for forming the image.

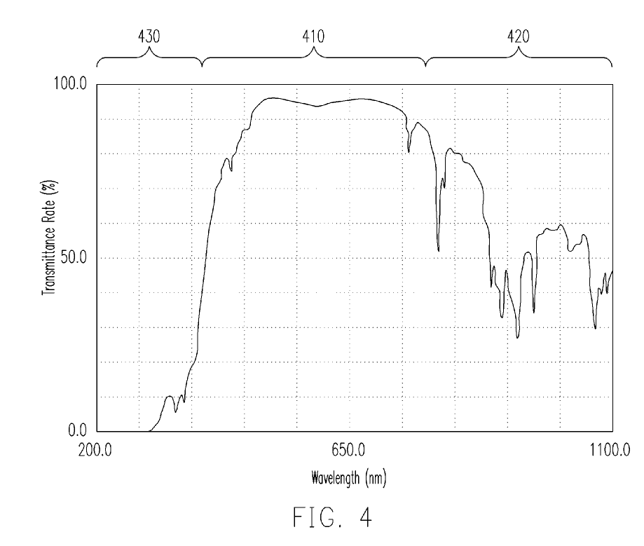

Please refer to the spectrum diagram shown in FIG. 4 for further illustrations of the capability of absorbing IR by the YAG filter.

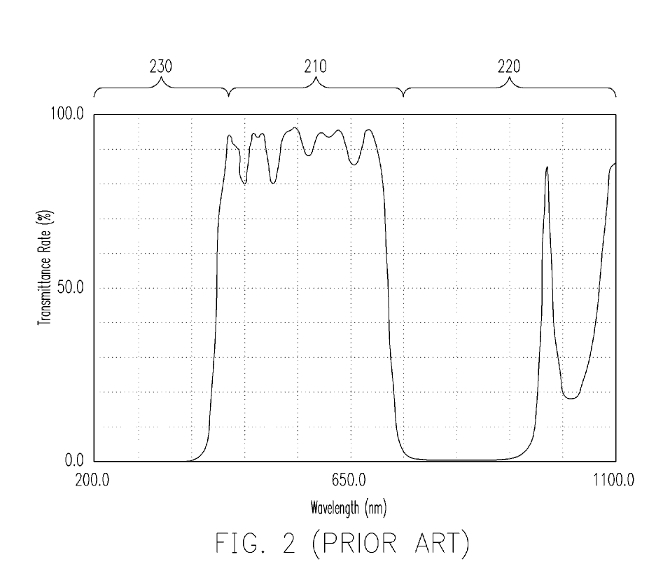

FIG. 4 schematically shows the measured spectrum of light beams after being filtered by the YAG filter 314 in the projection display apparatus of the present invention. Referring to FIG. 4, the averaged transmittance rate of visual lights is above 95% in the visual-light region 410 (wavelengths ranging from 400 nm to 700 nm), indicating the transmission effect of visual lights wouldn't be affected by the YAG filter 314 and an excellent brightness is maintained. In addition, the transmittance rate of UV lights 340b in the UV-region 430 (wavelengths ranging from 200 nm to 380 nm) is almost zero, namely, UV lights 340b can hardly penetrate through the YAG filter 314 and get reflected otherwise. Furthermore, the wave peaks for lights in the local IR-region 420 (wavelengths between 740 nm and 920 nm) still posses portion of the transmittance rate which tends to descend, and it means that only few of infrared rays 340a is reflected by the YAG filter 314, in comparison with the IR-region 220 shown in FIG. 2. And the results of FIG. 4 reveal that, most of infrared rays 340a can pass through the YAG filter 314 and they do not get reflected back to the locations where the light source and optical devices are. Therefore, the heat accumulation on the light source and optical devices can be avoided by using the YAG filter 314.

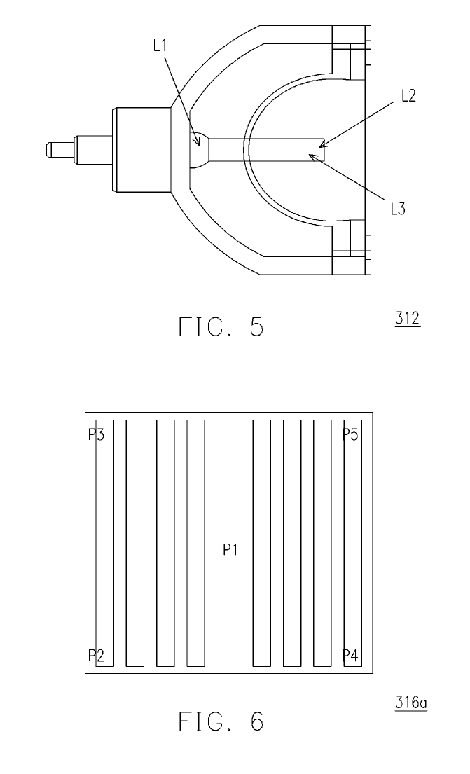

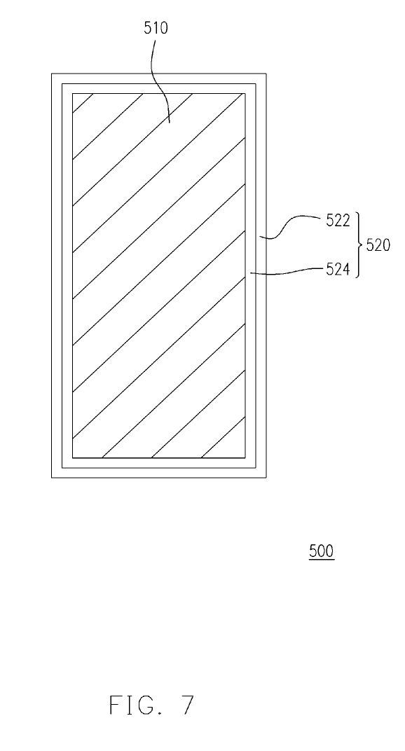

For further illustrations that heat accumulated in the light source and optical devices can be effectively eliminated via the YAG filter 314, please refer to results of temperature measurements sketched in FIGS. 5, 6 and Tab. 1.

FIG. 5 schematically shows temperature measurements of the light source of the projection display apparatus in the present invention by using thermal couples. FIG. 6 schematically shows the temperature measurements of the P-S converter of the projection display apparatus in the present invention by using thermal couples. In FIG. 5 and FIG. 6, the temperature differences between the projection display apparatus with YAG filter 314 and that without YAG filter 314 (i.e. to use UV/IR filter 114) are measured by using thermal couples mounted respectively on the positions of L1, L2, L3 of the light source and P1 to P5 of the P-S converter 316a. The results are shown in Tab. 1 below.

| Temperature ° C. | L1 | L2 | L3 | P1 | P2 | P3 | P4 | P5 |
|---|---|---|---|---|---|---|---|---|
| Without YAG | 649 | 274 | 339 | 45.2 | 34.1 | 38.6 | 32.6 | 47 |
| filter | | | | | | | | |
| With YAG filter | 594 | 238 | 307 | 40.7 | 32.6 | 36.1 | 31.1 | 44 |

Tab. 1 temperature differences measured with YAG filter and without YAG filter.

As can be seen from Tab. 1, the temperatures of the projection display apparatus with the YAG filter 314 measured are all lower than that of the projection display apparatus without the YAG filter 314. Accordingly, the YAG filter 314 based on the present invention can effectively eliminate the heat caused by the infrared rays and decrease temperature of the light source 312 and P-S converter 316a and thus extend their lifetime.

### The Second Embodiment

FIG. 7 schematically shows an optical filter according to one preferred embodiment of the present invention. Referring to FIG. 7, the optical filter 500 comprises an Yttrium Aluminum Garnet filter (YAG filter) 510 and at least one coating layer 520. Wherein, the coating layer 520 is disposed on the surface of the YAG filter 510. Except being able to absorb the infrared rays, the YAG filter 510 owns the characteristics including a high coefficient of thermal conductivity, a high melting point, a high transmittance rate, robust mechanical strength, and high insulation capability.

In one preferred embodiment of the present invention, the coating layer 520, for example, is an anti-reflective coating (AR coating) 522 used to raise the transmittance rate of visual lights, and a material of this AR coating, includes MgF₂ or Na₃AlF₆ for example.

In another embodiment of the present invention, the coating layer 520 mentioned above, for example, is an UV- blocking coating 524 for reflecting UV lights and a material of the UV-blocking coating 524, for example, is a blended material of TiO₂ and SiO₂.

In one another embodiment of the present invention, the coating layer 520 mentioned above includes both one AR coating 522 and one UV-blocking coating 524 for further improving performance of the YAG filter 510. For the sequence of the coating layers to be formed on the surface of the YAG filter 510, either the AR coating or the UV-blocking coating 524 is fabricated first. The optical filter 500 according to the present invention can be applied to the optical apparatus requiring the elimination of the infrared rays and ultraviolet rays to extend lifetime of the optical apparatus, such as a CCD projector or projecting apparatuses for example.

To sum up, the projection display apparatus and the optical filter according to the present invention have the merits as follows.

1. Due to the adoption of the Yttrium Aluminum Garnet filter (YAG filter) with a high coefficient of thermal conductivity, heat dissipation of the projection display apparatus is improved, heat of the infrared rays accumulated on the light source is reduced, and lifetime of the light source is extended.

2. The coating layer on the surface of the YAG filter is helpful in reflecting the UV lights, raising the transmittance rate of visual lights, preventing the UV lights from damaging the optical devices made of organic materials, and increasing utility efficiency of lights.

3. The optical filter based on the present invention can be applied on the related optical apparatus to reduce the heat caused by the infrared rays, and extend lifetime of the optical apparatus.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A projection display apparatus, comprising:
a light system comprising:
a light source suitable for providing a light beam;
a lens set disposed on the transmission path of the light beam; and
an Yttrium Aluminum Garnet filter (YAG filter) disposed between the light source and the lens set and on the transmission path of the light beam;
a projection lens disposed on the transmission path of the light beam; and
a display unit disposed between the lighting system and the projection lens and on the transmission path of the light beam.

2. The projection display apparatus according to claim 1, further comprising at least a coating layer disposed on the surface of the YAG filter.

3. The projection display apparatus according to claim 2, wherein the coating layer includes an anti-reflective coating (AR coating).

4. The projection display apparatus according to claim 3, wherein a material of the anti-reflective coating includes MgF₂ or Na₃AlF₆.

5. The projection display apparatus according to claim 2, wherein the coating layer includes an ultraviolet-blocking coating (UV-blocking coating).

6. The projection display apparatus according to claim 5, wherein a material of the UV-blocking coating includes a blended material of TiO₂ and SiO₂.

7. The projection display apparatus according to claim 2, wherein the coating layer includes an anti-reflective coating (AR coating) and an ultraviolet-blocking coating (UV-blocking coating).

8. The projection display apparatus according to claim 1, further comprising a heat-sink apparatus disposed on the side of the YAG filter.

9. The projection display apparatus according to claim 1, wherein the light source includes an ultra high pressure lamp (UHP lamp).

10. The projection display apparatus according to claim 1, wherein the lens set includes a polarization converter and a condenser lens.

11. The projection display apparatus according to claim 1, wherein the display device includes a color-combination prism and at least a display device, and the display unit is a liquid crystal on silicon (LCOS) display panel, a high temperature poly-silicon (HTPS) display panel, or the digital light processing (DLP) technique.

12. An optical filter comprising:
an Yttrium Aluminum Garnet (YAG) filter; and
at least a coating layer disposed on the surface of the YAG filter.

13. The optical filter according to claim 12, wherein the coating layer includes an anti-reflective coating (AR coating).

14. The optical filter according to claim 13, wherein a material of the anti-reflective coating (AR coating) includes MgF₂ or Na₃AlF₆.

15. The optical filter according to claim 12, wherein the coating layer includes an ultraviolet-blocking coating (UV-blocking coating).

16. The optical filter according to claim 15, wherein a material of the UV-blocking coating includes a blended material of TiO₂ and SiO₂.

17. The optical filter according to claim 12, wherein the coating layer includes an anti-reflective coating (AR coating) and an UV-blocking coating.
